(19) United States
(12) Patent Application Publication
(10) Pub. No.: US 2009/0204376 A1
(43) Pub. Date: Aug. 13, 2009

(54) Method for measuring a nonlinear dynamic real system

(75) Inventors: Nikolaus Keuth, Graz (AT); Thomas Ebner, Graz (AT); Horst Pflugl, Lannach (AT)

Correspondence Address: DYKEMA GOSSETT PLLC, FRANKLIN SQUARE, THIRD FLOOR WEST, 1300 I STREET, NW, WASHINGTON, DC, 20005, US

(73) Assignee: AVL LIST GMBH

(21) Appl. No.: 12/320,790

(22) Filed: Feb. 4, 2009

(30) Foreign Application Priority Data
Feb. 7, 2008 (AT) GM 71/2008

(51) Int. Cl. G06G 7/48

(52) U.S. Cl. 703/6

(57) ABSTRACT

In connection with generating a global model of output variables of a nonlinear dynamic real system, for example, of an internal combustion engine, a drive train, or a subsystem thereof that covers the entire space of all operating points of the system, a measurement of the system is performed for a subset of variation points that are defined by a set of parameters of the system.

In order to provide rapid and precise generation of the experimental designs, and the global optimization thereof, while taking into account the test constraints and additional criteria, at least two subsets selected as a function of each other are determined in succession, a common experimental design is generated taking into account the variation points of all subsets, and the system is measured based on this experimental design.

### BACKGROUND OF THE INVENTION

1. Field of the Invention

The invention relates to a method for measuring a nonlinear dynamic real system, for example, an internal combustion engine, a drive train, or a subsystem thereof, in connection with generating a global model of at least one output variable of the system for the entire space of all operating points of the system, including the measurement of the system for a subset of variation points, which variation points are defined by a set of parameters of the system.

2. The Prior Art

There is an ever-increasing need in the automotive field for efficient and accurate models since the calibration of the motor control system is becoming increasingly complex, and also increasingly expensive due to stricter and stricter regulatory requirements. The principal requirements for good models are good measurement data and an appropriately selected measurement design. As a result, the number of measurements and thus also the measurement period increases. However, since time on the test stand is very expensive, the need arises for effective experimental designs that minimize the number of measurement points, cover the test space as effectively as possible, while at the same time not qualitatively degrading the models trained using these data. These models are then used to optimize and calibrate ECU structures, or also to make decisions regarding components.

Based on local experimental designs that are generated using predetermined load and speed points, local models are currently being created and subsequently optimized locally, such as described, for example, in A. Bittermann, E. Kranawetter, J. Krenn, B. Ladein, T. Ebner, H. Altenstrasser, H. M. Koegeler, K. Gschweitl: “Emissionsauslegung des dieselmotorischen Fahrzeugantriebs mittels DoE-und Simulationsrechnung” [Emissions Design of a Diesel-Engine-Powered Vehicle Drive System Using DoE and Simulation Modeling]; MTZ Volume 65/6 (2004). The load\speed points are usually selected based on their frequency in the ECE+EUCD, or in other driving cycles, or arranged in grid-form. This has the disadvantage that either the test space in the load\speed plane is covered too poorly for a global model, or, on the other hand, too many points have to be measured, thereby causing the cost to rise enormously. Since it is mainly the exhaust gases that are very highly dependent on the load and the speed, and only to limited extent on variation parameters, such as, e.g., exhaust gas recirculation rate, ignition timing, it is necessary to create global models. The need thus arises for developing a design algorithm that takes this problem area into special consideration.

In the literature, what are principally found are mathematical standard methods that come from the chemical industry. In general, these algorithms can be divided into two groups. The one group of designs can be modeled analytically (CCD, BoxBenken, factorial designs). Examples of these are found in D. Montgomery, Design and Analysis of Experiments (5th Ed.) 2 (2001), John Wiley & Sons, Inc, or in W. Kleppmann:

“Taschenbuch der Versuchplanung” [Handbook of Experimental Design] (3rd. Ed.) (2003), Hanser Verlag. The second group is generated numerically by optimization algorithms, as is described, for example, in T. Santner, B. Willimans, W. Notz: “The Design and Analysis of Computer Experiments,” (2003) Springer New York.

The purpose of the method presented here is to generate experimental designs that are matched to typical applications in engines or drive train development, and calibration of the ECU or TCU. The method is intended to enable the quick and precise generation of experimental designs for global measurement, modeling, and optimization of a nonlinear dynamic real system, for example, of an internal combustion engine, a drive train, or subsystems thereof, as well as the global optimization thereof while taking into account experimental limits and additional criteria.

### SUMMARY OF THE INVENTION

In order to achieve this purpose, the method described in the introduction is characterized in that at least two subsets of variation points selected that are a function of one another are determined in succession, that a common experimental design is generated taking into account the variation points of all subsets, and the system is measured based on the experimental design.

In an advantageous embodiment, provision is made whereby the first subset is selected based on the parameters describing the main influencing variables. This ensures that a preselection of actually existing system points can be made.

Advantageously, the second and each additional subset is selected based on the parameters describing the secondary influencing variables. As a result, the number of system points required for the model and measurement can be achieved.

If, in further embodiment of the invention, the subsets of the parameters of the variation points do not intersect at least of the two first subsets of variation points do not intersect each other, effective coverage of the test space can be ensured.

In order to effect optimal coverage of the test space, a variant is advantageously provided in which no subset of the parameters of the variation points intersects another of the subsets.

Advantageously, provision is furthermore made whereby, starting with the second subset, in order to calculate this subset, information can be utilized from at least one of the respective prior selection operations as the selection criterion or influencing variable for the selection of the variation points of the system to be measured.

In one special embodiment, each subset can be selected based on a global test design.

Preferably, provision is made here whereby one test design uniformly filling the state space is used for at least the first subset.

Automation of the method according to the invention can be achieved to a high degree if the parameters describing the main influencing variables are determined automatically by means of a sensitivity analysis.

A further enhancement of the level of automation is achievable if the grouping of parameters for the individual stages is performed automatically, for example, by a cluster analysis.

The purpose of the following discussion is to describe the invention in more detail based on the attached drawings.

### BRIEF DESCRIPTION OF THE DRAWINGS

FIG. 1 depicts a graph of load versus speed in the method of generating a candidate set,

FIG. 2 illustrates the selection in FIG. 1 of the cell with the greatest minimal distance,

FIG. 3 is a diagram of the shift of the points outside the possible range in principle, and

FIG. 4 illustrates the test space with points according to an S-optimal with deletion of projections lines.

### DETAILED DISCUSSION

The method according to the invention was developed to generate global experimental designs and is adapted for training neural networks. The main goal here is to take into account the high dimensionality of the test spaces and any desired boundaries of the test space.

Various experimental designs are combined that are advantageous first of all in effectively covering test spaces in regions in which there is no knowledge about the condition of the nonlinearity to be mapped, and secondly in providing the ability to adapt the design to a specific expected model configuration. The generated experimental design is suitable principally for global stationary models based on neural networks, such as those disclosed in AT 7.710 U2. The data for modeling are captured on an engine test stand using appropriate software, e.g., using the software CAMEO developed by AVL List GmbH.

Generation of the design proceeds in three steps:

Preprocessing: Determining the components that have the greatest effect on the variables to be measured. Here the user can utilize all variables to be adjusted or only a subset to determine dependencies. The analysis is effected based on one output variable which is utilized subsequently for modeling. When multiple output variables are provided, the analysis is performed for each output variable and the results finally combined.

Step 2: First design for load/speed: The assumption is that the dependency of the target function is most strongly dependent on load and speed, and the model order is typically not known.

Step 3: Now a global design is created using the operating points selected in step 1, this design being optimized over the entire input space.

The advantage of this approach is, first of all, that the number of operating points can be precisely specified, and, secondly, that the load/speed range can be covered as well as possible with measurement points, thereby enabling an unknown nonlinearity to be captured along with subsequent modeling. Since the locally required model order or the interconnections between the variation parameters and the target function are known very precisely, it is possible in the second step to optimize globally for this model order. In the event these interconnections are not known, the test space can be effectively covered in the second test space by a space-filling experimental design.

Preprocessing:

In this step, the input variables are divided into two or more subgroups. These subgroups are differentiated by their effect on the out variables to be measured. The methodology of sensitivity analysis is used to do this, as described in: Chiang C. J. and A. G. Stefanopoulou: “Sensitivity Analysis of Combustion Timing and Duration of Homogeneous Charge Compression Ignition (HCCI) Engines,” Proceedings of ACC 2006, Minneapolis June 2006, or in Karsten Röpke, et al.: “Design of Experiments in Engine Development III,” expert Verlag, Berlin, 2007.

To this end, in a first step a star-domain design of experiments is run starting from a certain starting point in all variables to be measured. This ensures that only one input variable is varied per point. A fast actual-value measurement of the out variables of interest is made for each test point; this keeps the test duration as short as possible.

An established approach for determining the sensitivity is the normalization of the data to the interval between 0 and 1, as has already been described in T. Santner, B. Willimans, W. Notz: “The Design and Analysis of Computer Experiments,” (2003) Springer New York. Accordingly, the individual regression coefficients βᵢ are determined by a linear regression. Subsequently, a t-test is used to determine the significance of the individual coefficients.

In order to test the hypothesis βᵢ=0, the so-called Z-score is computed:

$${z}_{i} = \frac{{\hat{β}}_{i}}{\hat{σ} \sqrt{{v}_{i}}}$$

where vᵢ corresponds to the j-th diagonal element in (X^{T}X)⁻¹. zᵢ is then t-distributed with N-p-1 $ degrees of freedom under the assumption of the null hypothesis. Additional information can be found in T. Hastie, R. Tibishirani, J. Friedman, “The Elements of Statistical Learning Data Mining, Inference, and Prediction,” Springer, Corr. 3rd printing edition (Jul. 30, 2003).

The larger the value of zᵢ, the larger the effect of the corresponding channel on the output. In addition, the sensitivity of the individual inputs on the output can be determined as indicated in T. Santner, B. Willimans, W. Notz: “The Design and Analysis of Computer Experiments,” (2003) Springer New York.

Based on a significance level indicated by the user, the channels can be subsequently divided into two groups. The first group of input variables is now used in the first step of the design of the experiment. The remaining input variables go into the second step.

In the case of diesel engines, the first group is usually composed of the input variables for load and speed. The variation variables are used in the second step of the algorithm.

Step 1:

In this step, a selection can be made between two experimental designs—specifically, based on the LHS design or the S-optimal (space-optimal) design.

Both designs take into account the constraints in the load/speed direction. This achieved here through the candidate list in the case of the S-optimal design, whereas points are shifted subsequently in the case of the LHS design.

LHS Design:

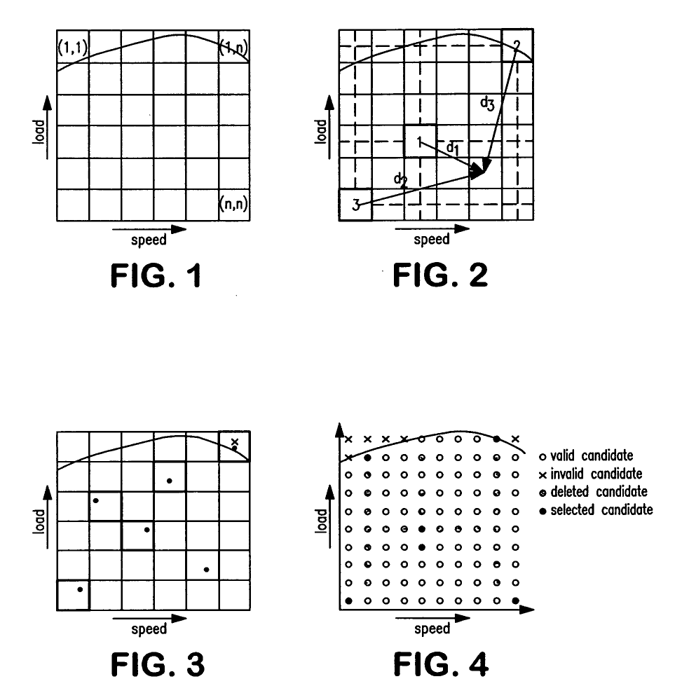

As specified by the user, n points are distributed within the test space according to the principle of LHS (Latin Hypercube Sampling). During generation, the design is optimized in terms of the distance of the points. What is attempted here is to place the points such that the minimum distance of all points is at maximum in the design. The procedure here is to divide the test space into n×n squares, as illustrated in FIG. 1. Each of these squares contains a coordinate pair (1,1), (1,2) . . . (1,n) . . . (n,n). One thus obtains a candidate set. The cell at the center is selected as the starting point for the optimization. Now all cells are removed from the candidate list that lie on the projections of the cell onto the axes. What is achieved thereby is that the points are equally distributed in each direction in the final design. The next cell that is added is the one that has the maximum distance to the first cell. The distance between cells l and m can be calculated by the following equation: d=sqrt((xl1−xm1)2+(xl2−xm2)2). Once the cell with the maximum minimal distance (see FIG. 2) is found, its coordinates are added to the design list and all points on the projections are removed. After n cells have been selected by this approach, a random point is selected in each cell. In order to check the constraints, these points are mapped to a specified candidate set. This ensures that the design only contains drivable and adjustable load/speed points. Any points outside the constraints are deleted from the design. In order to attain the desired n operating points, only those points from the candidate set are added to these which lie within the drivable range, as is shown in FIG. 3. For this purpose, the minimum distance of all candidates to the design are computed and each candidate is added which has the maximum minimal distance to the design. This step is repeated until the design consists of n points. What is thus obtained is an LHS-like design with n points in the curvilinearly bounded space.

These load/speed—points (operating points) are used in the second step to generate the global experimental design.

S-Optimal Design:

For the S-optimal design, a candidate set is used in the form of a grid from which points outside the drivable range have been removed. That grid point is selected as the starting value which is closest to the center. Then those points from the candidate set are added to the design which have the maximum minimal distance from the current design. In order to prevent the design from again forming a grid, many points lie on the same projection line, points on the projection lines of the points located in the design are removed from the candidate set. Only, however, when the point that was just added to the design is not located on the boundary of the operating range, as is shown in FIG. 4.

The purpose of this measure is to achieve two effects—specifically, the best-possible coverage of the boundaries, as well as a uniform distribution of the points over the measurement range.

Inclusions

In order to give the user the ability to add specific operating points to the design, while also achieving a varying point density in different regions, it is necessary to enable inclusions in both algorithms. In both cases, this can be achieved by different approaches.

LHS Design:

If d-points are to be used as inclusions and n-points are added to the experimental design, the operating range is divided into (n+d)×(n+d) cells. Subsequently, those cells are searched in which the inclusions come to be situated and these are removed from the candidate set. In addition, all cells that lie on the projections onto the axes are also removed. After this, the actual generation of the experimental design is begun. Again that cell is selected that has the maximum minimal distance from the cells in which the inclusions lie. From here on, the algorithm proceeds as was described earlier.

S-Optimal Design:

It is very simple to integrate inclusions here. Here the design is not started from an initial candidate, but instead that candidate is searched for which has the maximum minimal distance from the inclusions. Generation of the experimental design is then handled as described above.

Step 2—n: experimental design local plane globally optimized.

Here two variants are used, a global S-optimal design or a global D-optimal design.

In both variants, a candidate set is used which is based on operating points that are selected in step 1.

The following parameters are taken into account during optimization of the experimental design: The minimum number of points per operating point (BP) is definable, the standard deviation of points/BP is definable, and the maximum number of points/BP is definable.

This purpose here is to ensure that at least one measurement point lies in each BP, i.e., BPs cannot become lost in the global experimental design. What is achieved by the condition involving the standard deviation is that the entire space is filled with measurement points and thus existing nonlinearities can be discovered more effectively.

S-Optimal Design (Global)

The S-optimal design functions in a manner analogous to the S-optimal design for speed/load from step 1. Points on projection lines, however, are removed here only locally from the candidate set, i.e., only in the current BP.

The points are selected such that the new point has the maximum distance from the points in the experimental design. The point at the center of the engine characteristic map is selected as the starting point. In addition to the distance, the three criteria above are also checked before a point is added to the experimental design.

The advantage of this design is the lower memory cost, and simpler and faster computation. The disadvantage is that the user cannot incorporate any previous knowledge on the expected model order in the experimental design.

D-Optimal Design (Global)

Here the user has the ability to specify the expected model order. Since the design is optimized globally, a model order for speed/load must also be specified. Higher-order models should be selected here, whereas the model order for the variation channels can be lower. The minimum required number of points is computed from the number of terms that are specified by the model order.

The points are distributed in the test space such that on the one hand the determinants of the information matrix det(M)=det(X′X) is maximized (maximization of the enclosed volume) and, on the other hand, the three conditions above are met. In addition, points in the design are not measured twice to maximize the information gain. Repetition points must be added manually at the end. The problematic aspect of this design is the high computing and memory cost. As a result, the number of points in the candidate set must be kept low.

Another difficulty consists in finding an appropriate starting design. The points are selected here such that their regressors are as far as possible orthogonal to each other and the distance between them is at maximum. This approach achieves a distribution of points in the space that has a very high resemblance to a D-optimal design. The selection of the starting experimental design enables the necessary iteration steps to be reduced in order to generate a D-optimal experimental design, and this can be of beneficial effect especially in the case of high-dimension test spaces.

Beginning with the starting design, points are added to the design until the desired number of points is reached. Subsequently, one point from the candidate set is always exchanged for a point from the experimental design until no further improvement of the determinants can be achieved. The three constraints of step 2 are also checked and adhered to during this exchange process.

1. A method of measuring a nonlinear dynamic real system for generating a global model of at least one output variable of the system for the total space of all operating points of the system, comprising measuring the system for a subset of variation points that are defined by a set of parameters of the system, selecting first and second subsets as a function of each other in succession, generating a common experimental design, and measuring the system based on said experimental design by taking the variation points into account.

2. The method according to claim 1, comprising selecting the first subset based on parameters describing main influencing variables.

3. The method according to claim 2, comprising selecting the second and each additional subset based on parameters describing secondary influencing variables.

4. The method according to claim 3, wherein the subsets of the parameters of the variation points of at least the two first subsets of variation points do not intersect each other.

5. The method according to claim 4, wherein no subset of the parameters of the variation points intersects another of the subsets.

6. The method according to claim 5, wherein starting with the second subset, in order to calculate this subset, information can be utilized from at least one respective prior selection operation as the selection criterion or influencing variable for the selection of the variation points of the system to be measured.

7. The method according to claim 6, wherein each subset is selected based on a global test design.

8. The method according to claim 7, wherein a test design uniformly filling the state space is employed for at least the first subset.

9. The method according to claim 8, wherein the parameters describing the main influencing variables are determined automatically by means of a sensitivity analysis.

10. The method according to claim 9, wherein the grouping of the parameters is performed automatically for the individual steps.
